(19) United States
(12) Patent Application Publication
(10) Pub. No.: US 2004/0182669 A1
(43) Pub. Date: Sep. 23, 2004

(54) Hand shifter with integral clutch release lever for motorcycle or ATV

(75) Inventor: David Paul Thompson, Antrim, NH (US)

Correspondence Address: DAVID P. THOMPSON, 59 WEST ST., ANTRIM, NH, 03440, US

(73) Assignee: David Paul Thompson, Antrim, NH (US)

(21) Appl. No.: 10/249,164

(22) Filed: Mar. 19, 2003

(51) Int. Cl. B60K 41/22

(52) U.S. Cl. 192/3.57; 192/3.62; 192/99 S

(57) ABSTRACT

A shifter handle for a motorcycle or ATV which has an integral clutch release lever, operable by the fingers of the same hand used for shifting the gears. Being mounted in either the jockey position, adjacent to the seat, or the tank shift position which is mounted vertically from the shifter pedal shaft, the clutch controls are removed from the handlebars making said clutch release lever integral to the handle used for shifting the gears. Trends in the custom cruiser industry are to remove the visible controls from the handlebar area for aesthetic purposes. There are important applications such as the area of modification for the handicapped. Spinal cord injured persons with little or no use of the legs, or amputees where a foot shift device is impossible to use need no longer be prohibited from enjoying riding this type machine. The hand shift devices of the past are no longer precarious or dangerous with both operations in the same hand. This does away with the negative aspects of the jockey shifters of the past where it was difficult to put the clutching foot down on the ground for support. This invention allows for the use of either the stock clutch release components or for upgrade to hydraulic components to actuate the clutch release mechanism.

### BACKGROUND OF INVENTION

The background art in the motorcycle and ATV industry has included various different clutching and shifting configurations. Typical shifting and clutching configurations include for example: U.S. Pat. No. 1,110,249 issued to Bailey. This patent discloses a variable speed transmission mechanism for motorcycles which includes a shifter adjacent to the seat for purpose of gear selection. hen used in conjunction with a foot operated clutching device, gear selection is possible, if slightly precarious. This configuration is commonly referred to as the jockey shifter. The inability to remove the foot from the clutch pedal when slowing or coming to a stop, unless the shifter is in the neutral position, makes this configuration dangerous. Another type of shifting device is described in U.S. Pat. No. 2,094,163 issued to Weber. This type of device unites foot and hand operated controls on the handlebar using a link and lever mechanism, but does not completely convert shifting and clutching duties to hand controlled means. U.S. Pat. No. 4,741,222 issued to Brendt describes a shifting device wherein movement of a standard foot operated shifter pedal is achieved through the use of a lever and handle attached to the stock shifter pedal by means of a clamp, allowing the use of either the hand or the foot to operate the shifting mechanism. Further U.S. Pat. No. 5,299,652 issued to Bevins describes a handlebar mounted shifting device comprised of both upshift and downshift buttons used in conjunction with a clutch release which is actuated by air or electric means. All the shifting and clutching functions are mounted on the handlebars in this configuration.

Other U.S. Patents with the same basic shifting and clutching functions are Pat. No. 2,61 7,505 issued to Tatge or U.S. Pat. No. 2,600,767 issued to Harrel, both of which relate to foot operated shifting and clutching mechanisms. U.S. Pat. No. 2,540,926 issued to Zook comprises a conversion package which allows both hands and feet to remain in their normal riding postures while performing shifting and clutching duties. None of the aforementioned references described a mechanism or package for converting both shifting and clutching tasks to one handed operation, with no need for the foot to shift gears or operate the clutch, and removes them from the handlebars to a manageable location. The current trend in the3 custom motorcycle industry is to remove all visible controls from the handlebar are to achieve a cleaner less jumbled look. Many motorcycle builders use the design put forth in U.S. Pat. No. 1,110,249 issued to Bailey, which uses a jockey shift handle adjacent to the seat to shift gears, while clutching is achieved by means of a foot operated pedal above the left foot peg or floor board. This combination has proven precarious and is commonly referred to as the suicide shifter.

### SUMMARY OF INVENTION

This invention will allow the rider to operate the clutch with the fingers of the left hand, on motorcycles or ATVs with right hand throttle, and shift gears with a movement of the same hand, removing the clutching and shifting controls from the handlebar area completely, and putting both controls either adjacent to the seat area, in the jockey shift position, or in the forward mounted tank shift position, in place of the stock shifter pedal. With the current trend in aesthetics being to remove all visible controls from the handlebar area, this type of device offers not only improved aesthetics, but also a manageable and easily installed shifting and clutching device for use by handicapped persons with limited or no use of the legs.

### BRIEF DESCRIPTION OF DRAWINGS

FIG. 1 Shifter handle for hand shifting gears of motorcycle or ATV with integral clutch release mechanism. This preferred embodiment is shown in the hydraulic version with the hydraulic fluid reservoir inside the grip and the master cylinder machined into the handles interior.

FIG. 2 Hydraulic embodiment of shifter handle in the shorter, jockey shift configuration with internal hydraulic fluid channels.

FIG. 3 Clutch release lever.

FIG. 4 Adjustable push rod.

FIG. 5 Hydraulic Piston.

FIG. 6 Reservoir cap.

FIG. 7 Mount plate for Harley Davidson models with seat post.

FIG. 8 Pivot Shaft, used only on jockey shift units.

FIG. 9 Bearing Carrier, pivots around pivot shaft above.

FIG. 10 End cap holds bearing carrier in place.

FIG. 11 and FIG. 12 are shoulder bushings or can be replaced with needle bearings.

FIG. 13 Clevis pin and cotter pin attach shifter linkage to bell crank at one end and to transmission at the other.

FIG. 14 Shifter linkage attaches transmission shifter arm and shifter bell crank.

FIG. 15 Longer version of shifter linkage for custom applications.

FIG. 16 Bell crank

FIG. 17 Jockey shift configuration shown installed on motorcycle. Stock sifter parts used in tank shift 5 installation are shown also.

FIG. 18 Cable actuated configuration with pinch bolt type mount for installation on stock shifter shaft, used with stock shifter linkage and bell crank.

17. Hydraulic fluid

18. Threaded port for fitting of hydraulic hose.

19. Internal passageway for hydraulic fluid.

20. Hydraulic reservoi9r.

21. Internal passageway from reservoir to master cylinder.

22. Master Cylinder.

23. Twelve holes to engage roll pins for angle adjustment.

24. Roll pins

25. Small hole in bell crank to attach linkage.

26. Stock shifter shaft with pedal removed.

27. Seat.

28. Transmission shifter arm.

29. Point where stock linkage disconnects for removal prior to jockey installation.

30. Stock shifter bell crank.

31. Hydraulic hose or cable.

32. Stock shifter linkage for foot operated shifter.

33. Machined groove for cable housing to be held in place inside underside of shifter handle.

34. Point where cable housing exits shifter handle.

35. Slotted hole which allows for tightening of tank mounted version onto stock shifter shaft where stock pedal was removed.

36. Bolt which tightens above slotted hole in tank mounted version of shifter handle.

37. Hydraulic fluid.

38. Threaded port for attachment of hydraulic hose.

### DETAILED DESCRIPTION

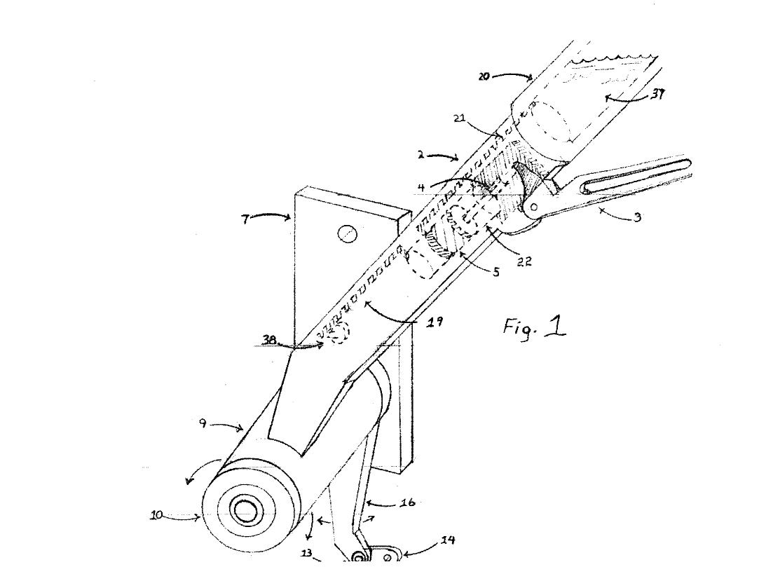

FIG. 1 Hand shift device with integral clutch release lever shown in the preferred embodiment with internal hydraulic reservoir and passageways to carry hydraulic fluid to and from the master cylinder machined into the handle. This version of the invention is shown with the necessary requirements for the jockey shift configuration with hydraulic clutch actuation. As the clutch release lever is actuated with the fingers, the gears are selected with a forward or rearward push of the same hand.FIG. 2 Shifter handle seen in FIG. 2 is the preferred embodiment. A short version of said handle is affixed to the bearing carrier FIG. 9 by weld or internal bolts, at an angle which enables forward and rearward rotation of said bearing carrier FIG. 9. In the hydraulic version the master cylinder 22 FIG. 2 is machined directly into the interior of the handle, or can be configured as a cartridge which installs onto or into the handle. The grip 20 FIG. 1 is the hydraulic reservoir for the hydraulic fluid 37 FIG. 1. The internal passageways 19 and 21 FIG. 1, can also be small hydraulic lines laid into grooves which are machined into the bottom side of the handle. Fittings can be attached at 38 FIG. 1 for attachment of hydraulic hose 31 FIG. 4 to carry fluid pressure to required hydraulic clutch release cover. Fluid 37 FIG. 1 is carried through passageway 21 FIG. 1 to master Cylinder 22 FIG. 1. Piston 5 FIG. 1 is then actuated by clutch release lever 3 FIG. 1, forces fluid out through passageway 19 FIG. 1 to threaded port 18 FIG. 1. Ultimately the pressure is transferred through the hose to actuate the required hydraulic clutch release cover.

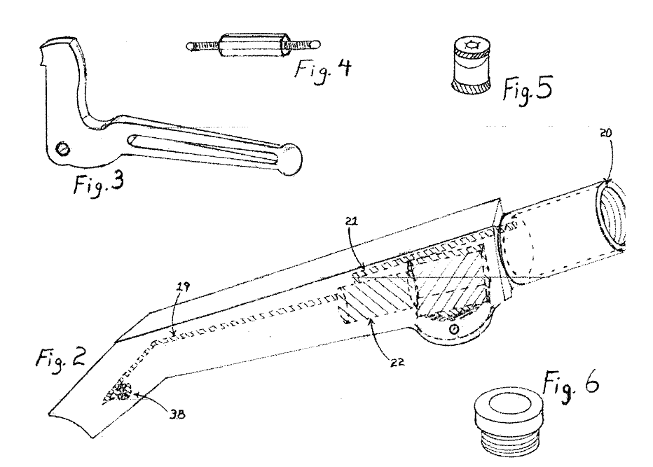

FIG. 3 Clutch release lever when pulled, pivots about the mounting screw and forces push rod 4 FIG. 1 to push piston 5 FIG. 1 down into the master cylinder 22 FIG. 2, forcing hydraulic fluid 37 FIG. 1 out through the hose.

FIG. 4 Adjustable push rod is expandable in length for adjustable throw.

FIG. 5 The piston is of the single circuit automotive type. Can be nylon or plastic with o-ring groove to the rear preventing escape of fluid out the back and a cupped rubber cup type seal in the front. Common brake seal cups would suffice as long as fluid and seals are compatible.

FIG. 6 Reservoir cap is threaded into reservoir to keep fluid from spilling out while allowing for refilling.

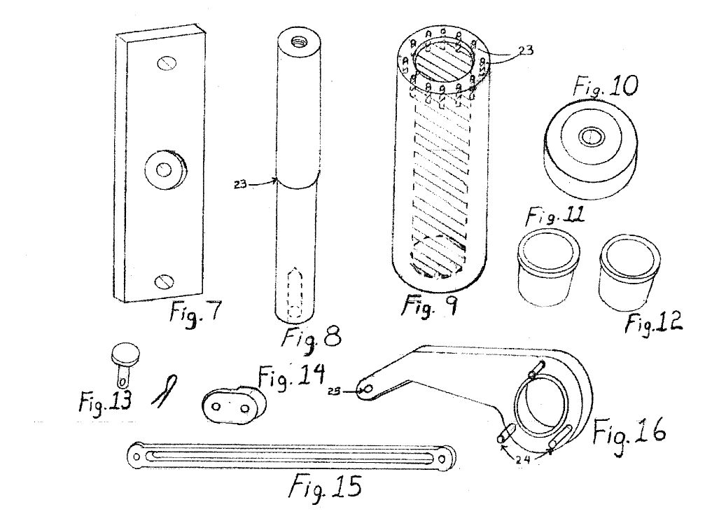

FIG. 7 Mount plate is shown in a configuration which allows for mounting to a Harley Davidson frame which has a seat post which allows the relocation of the coil to a different spot leaving the mount holes for the shifter. Other designs of the mount plate would allow for use of jockey shift configuration on many different models, but would require relocation of mounting holes.

FIG. 8 Pivot shaft is required for any jockey shift configuration but can be mounted to many different mount plates. Length of the shaft and placement of the shoulder 23 FIG. 8 determine final positioning of bearing carrier 9 FIG. 1, and can be made to different lengths to maximize mounting versatility. Diameter of the shaft fits bushings or bearings correctly to allow bell crank 9 FIG. 1 to rotate freely.

FIG. 9 Bearing carrier has the shifter handle attached by means of weld or inside bolts and has bushing FIG. 12 pressed into one end. The other end has twelve equally spaced holes around the perimeter which engage the thee roll pins in the bell crank, forcing it to pull the shifter linkage and actuate the shifter arm. The holes engage the roll pins allowing for angle adjustment of the handle. The other bushing is pressed into the bell cranks center.

FIG. 10 End cap holds the bearing carrier in place by means of the bolt through the center which threads into the end of the pivot shaft.

FIG. 11 and FIG. 12 are the two shoulder bushings, or can be substituted for two needle bearings, which are pressed into the bearing carrier and the bell crank allowing the handle and the bearing carrier to pivot around the pivot shaft.

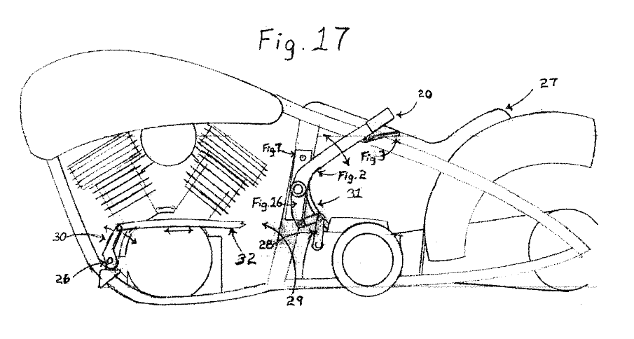

FIG. 13 Clevis pin attaches the shifter linkage to both the bell crank and the transmission shifter arm 28 FIG. 17, and is held there by means of a cotter pin.

FIG. 14 Shifter linkage attaches bell crank to transmission shifter arm.

FIG. 15 A longer version of the shifter linkage which can be substituted in a custom application.

FIG. 16 Bell crank transmits rotational forces to a larger radius which gains throw in both the push and pull directions. Affixed to the end of the bearing carrier by means of the three roll pins 24 FIG. 16 which are pressed into the bell crank. Pulls and pushes the transmission actuator arm 28 FIG. 17 for gear selection.

FIG. 17 Side view of motorcycle showing the jockey shift embodiment of this invention installed adjacent to the seat area. Stock foot shift parts, which are required for installation of tank shift version of this invention, are also shown here.

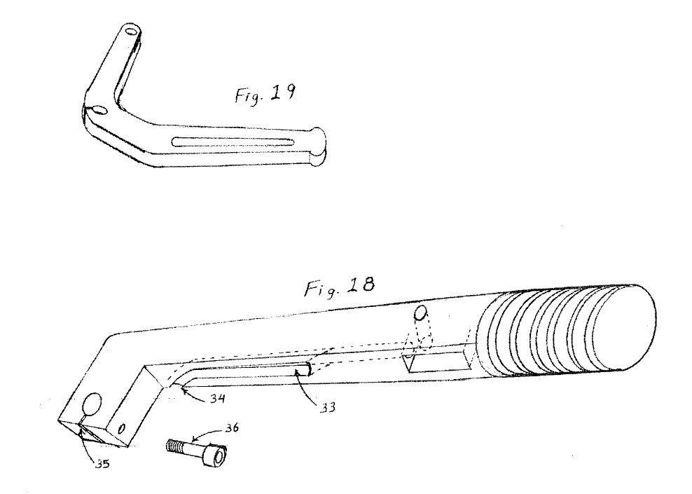

FIG. 18 Tank mounted version of shifter handle with integral clutch lever which uses stock type clutch release cable and is mounted onto stock shifter pedal shaft.

19. Internal passageway which carries hydraulic fluid from master cylinder 22 FIG. 1 to exit port 38 FIG. 1. Can be tubing laid into grooves.

20. Reservoir as shown in FIGS. 1 and 2 is machined into the handles grip on hydraulic versions of this invention.

21. Internal passageway which feeds fluid from reservoir 20 FIG. 1 to master cylinder 22 FIG. 1. Can be a groove machined to accept a hydraulic tube.

22. Master Cylinder is shown in FIGS. 1 and 2 machined into the interior of the shifter handle, but could also be a cartridge which installs either inside the handles interior or on the side of the handle. The hydraulic fluid is squeezed out of the master cylinder when the piston 5 FIG. 1 is forced down by the movement of the clutch release lever 3 FIG. 1. Only required in the hydraulic embodiment of this invention.

23. Twelve equally spaced holes around the perimeter of one end of the bearing carrier FIG. 9. These allow the three roll pins 24 FIG. 9 to engage the bell crank 9 FIG. 1 in different positions for adjustment.

24. Three roll pins which are pressed into the bell crank FIG. 9.

25. Hole at the lower end of the bell crank which allows the shifter linkage to attach there via a clevis pin FIG. 13.

26. Stock shifter shaft which originally carried the shifter pedal. Used to mount the shifter handle in the tank mounted configuration, removed for the jockey shift configuration.

27. Seat.

28. Transmission shifter arm. This part of the original transmission is what the shifter handle is designed to actuate.

29. Point where original equipment shifter shaft is disengaged to install jockey style shifter.

30. Stock foot shift bell crank. This piece is used for tank shift version and discarded for the jockey style version.

31. Hydraulic hose routes the pressure provided by the shifter handle with the hydraulic version of the integral clutch release lever, to the required hydraulic clutch release cover.

32. Stock shifter linkage from foot operated shifter.

33. Groove machined into the bottom side of the shifter handle to hold cable housing in place and hidden.

34. Point in cable actuated version of shifter handle where cable housing exits hidden groove.

35. Slotted hole which allows tank mounted version of shifter handle to be mounted to stock shifter shaft. Slot allows hole to tighten around shaft when bolt is tightened.

36. Bolt to tighten slotted hole above.

I claim

1. An improved hand operated shifter device with integral clutch release lever, having hand controlled clutch release and engagement capabilities, where forward and aft rotational shifter lever motion is transposed into a semi linear motion, parallel to the axis of the motorcycle or ATV, which articulates transmission shifter arm by means of a mechanical apparatus comprised of: A hand shift handle welded to or bolted internally to a bearing carrier which rotates around a shaft which protrudes perpendicular to the axis of the motorcycle or ATV adjacent to the seat, about which pivots a bearing carrier and bell crank combination with a handle attached, which transposes rotational forces applied to the handle into semi linear forces which actuate the transmission shifter arm for purposes of gear selection.

2. An improvement of claim 1 which is an integral clutch release lever built into the handle which is used to shift gears on motorcycle or ATV, and which is located in such a manner that it is operable by the fingers of the same hand which is used to shift the gears.

3. An Improvement of claim 2 where the controls for the clutch and the controls for the shifting device are combined into one hand operated mechanism being located under the seat in the jockey position, and having a hydraulic clutch release mechanism with the reservoir inside the grip section of said handle.

4. An improvement of claim 3 where the master cylinder is comprised of a machined cartridge which is machined and finished, then installed into the inside of the handle or onto the side of said handle where it is plumbed in with tubing and hidden inside channels machined there for that purpose.

5. An improvement of claim 3 where the master cylinder is machined directly into the interior of said handle, with passages for fluid machined into the interior as well To carry fluid from the reservoir to the master cylinder and then from the master cylinder to the exit port, which provides pressure to the hydraulic hose and eventually to the required clutch release cover.

6. An improvement of claim 1 which is the removal of both clutching and shifting mechanisms from the handlebar area and into the control of one hand, said shifting and clutching device to be located in the tank mounted position, vertically mounted from the shaft where the shifter pedal was removed, adjacent to the foot peg or floorboard, on the left side of motorcycle or ATV, removing both shifting and clutching duties from the handlebars and having both operations performed by the same hand, while making use of the stock clutch release cable and the stock clutch release cover.

7. An improvement of claim 6 which is the relocation of said shifter handle with integral clutch release lever, and using the stock clutch release cable and housing with the stock clutch release cover, to the jockey position, adjacent to the seat area, and having most of the clutch release cable housing hidden inside the shifter handle.

8. A hand shift device with integral clutch release mechanism as in claims 3, 6 and 7 and being either mounted to or pivoting upon frame of motorcycle or ATV, where both clutching and shifting procedures are performed by one hand, with no foot control required, and which modifies rider controls for operation by persons with little or no use of the legs, thereby improving the arrangement of the controls for use by persons with handicaps or limited foot mobility.
